(19) United States
(12) Patent Application Publication
(10) Pub. No.: US 2026/0079762 A1
(43) Pub. Date: Mar. 19, 2026

(54) METHODS AND APPARATUS FOR CONTROLLING PREDICTION UNITS

(71) Applicant: Arm Limited, Cambridge (GB)

(72) Inventors: Mbou Eyole, Soham (GB); Frederic Claude Marie Piry, Cagnes Sur Mer (FR)

(73) Assignee: Arm Limited, Cambridge (GB)

(21) Appl. No.: 19/108,554

(22) PCT Filed: Jul. 19, 2023
(86) PCT No.: PCT/GB2023/051890

§ 371 Date: Mar. 4, 2025

(30) Foreign Application Priority Data
Sep. 9, 2022 (GB) 2213241.9

(51) Int. Cl. G06F 9/50; G06F 11/34

(52) U.S. Cl. CPC G06F 9/5044; G06F 9/5033; G06F 11/3409

(57) ABSTRACT

Aspects of the present disclosure relate to apparatus comprising prediction circuitry comprising a plurality of prediction units, said plurality comprising a plurality of types of prediction unit. Each prediction unit is configured to perform a corresponding type of prediction in respect of operations that are to be executed by the apparatus. Shared prediction resource circuitry comprises shared prediction resources configurable to perform said types of prediction. Resource allocation circuitry is configured to determine an allocation of said shared prediction resources to one or more of said plurality of prediction units, and allocate the shared prediction resources according to the determination.

### BACKGROUND

The present technique relates to the field of prediction units associated with processing circuitry. Such prediction units are used to make predictions about upcoming processing that is yet to be performed by the processing circuitry. This can significantly improve the performance of the processing circuitry. For example, a prefetcher can predict instruction addresses or data addresses and fetch the corresponding instructions and/or data from storage prior to a processing flow reaching the point at which such instructions or data are explicitly requested. The prefetched instructions and/or data are thus ready to be accessed, for example by being held in a short-term storage such as a cache which is faster to access than longer-term but slower-to-access storage such as a memory. This improves performance because the prefetched instructions and/or data can be quickly accessed when requested, without incurring that delay that would be associated with fetching them from the longer-term storage.

Other types of prediction unit can also be used, for example branch predictors which predict the outcome of branch instructions. In some systems, many types of predictors are used simultaneously.

Whilst predictors can significantly improve processing performance, they also incur an overhead in terms of processing resources and power consumption. This effect is increased when multiple types of predictor are implemented simultaneously. There is therefore a desire for a way of increasing the level of prediction functionality that can be provided, whilst reducing their overall resource usage.

### SUMMARY

At least some examples provide an apparatus comprising:
prediction circuitry comprising a plurality of prediction units, said plurality comprising a plurality of types of prediction unit, each prediction unit being configured to perform a corresponding type of prediction in respect of operations that are to be executed by the apparatus;
shared prediction resource circuitry comprising shared prediction resources configurable to perform said types of prediction; and
resource allocation circuitry configured to:
   determine an allocation of said shared prediction resources to one or more of said plurality of prediction units; and
   allocate the shared prediction resources according to the determination.

Further examples provide a method comprising:
performing a plurality of types of prediction in respect of operations that are to be executed, each type of prediction being performed by a corresponding prediction unit;
determining an allocation of shared prediction resources to one or more of said plurality of prediction units, the shared prediction resources being configurable to perform each of said types of prediction; and
allocating the shared prediction resources according to the determination.

Further examples provide a non-transitory computer-readable medium to store computer-readable code for fabrication of an apparatus comprising:
prediction circuitry comprising a plurality of prediction units, said plurality comprising a plurality of types of prediction unit, each prediction unit being configured to perform a corresponding type of prediction in respect of operations that are to be executed by the apparatus;
shared prediction resource circuitry comprising shared prediction resources configurable to perform said types of prediction; and
resource allocation circuitry configured to:
   determine an allocation of said shared prediction resources to one or more of said plurality of prediction units; and
allocate the shared prediction resources according to the determination.

Further examples provide a computer program for controlling a host data processing apparatus to provide an instruction execution environment comprising:
prediction logic implementing a plurality of prediction units, said plurality comprising a plurality of types of prediction unit, each prediction unit being configured to perform a corresponding type of prediction in respect of operations that are to be executed within the instruction execution environment;
shared prediction resource logic comprising shared prediction resources configurable to perform said types of prediction; and
resource allocation logic configured to:
   determine an allocation of said shared prediction resources to one or more of said plurality of prediction units; and
allocate the shared prediction resources according to the determination.

Further aspects, features and advantages of the present technique will be apparent from the following description of examples, which is to be read in conjunction with the accompanying drawings.

### BRIEF DESCRIPTION OF THE DRAWINGS

FIG. 1 schematically depicts an apparatus according to an example.

FIGS. 2A to 2C depict example allocations of resources to prediction units.

FIGS. 3A and 3B depict example methods.

FIG. 4 illustrates an example method.

FIG. 5 depicts a system according to an example.

FIG. 6 shows an example method.

FIG. 7 shows an example method.

FIG. 8 depicts a computer-readable medium according to an example.

FIG. 9 depicts an example implementation by way of a simulator.

### DESCRIPTION OF EXAMPLES

In an example, an apparatus (for example a processing apparatus such as a central processing unit or graphics processing unit) comprises prediction circuitry having a plurality of prediction units. These prediction units have various types, such that the prediction circuitry comprises a plurality of types of prediction unit, each being configured to perform a corresponding type of prediction in respect of operations that are to be executed by the apparatus. These operations may be instructions, such as program instructions and/or hardware signals which direct the apparatus to perform processing actions.

One skilled in the art will appreciate that various types of prediction unit can be implemented in the present example. A non-limiting list of such prediction unit types is:
branch predictors, which predict the outcome of branch instructions;
data prefetchers, which predict data on which subsequent instructions will act;
instruction prefetchers, which predict future instructions;
load, or store-coalescing predictors, which predict opportunities for grouping, or coalescing, accesses to the same storage granule in order to maximise utilisation of available memory bandwidth;
congestion predictors, which identify bottlenecks in the transfer of data between functional units and/or processing units of the apparatus, to allow data to be re-routed accordingly;
execution cluster predictors, which identify which functional units are best placed to execute particular instructions in order to improve efficiency and speed up the forwarding of results;
address collision predictors, which predict whether a data hazard will occur when a load overtakes a store during out-of-order instructions execution. That is, when loads are executed out of program order relative to stores, there exists a possibility that a younger load from a given address will overtake an older store to the same address (causing an error) and an address collision predictor tries to determine the likelihood of this sequence of events;
snoop predictors, which predict the likelihood of a memory coherency violation.

The apparatus further comprises shared prediction resource circuitry, which comprises shared prediction resources configurable to perform the above-described types of prediction. The shared resources are shared between the processing units, and at any given time can be allocated to one or more such processing units. The shared prediction resources may include one or more storage units or memory units, such as registers and/or static random access memory (SRAM). The shared prediction resources may also include one or more processing resource units, such as lookup tables. These lookup tables may be general-purpose lookup tables which are configurable for use by multiple prediction unit types. The shared prediction resources may further comprise interconnect resources.

The apparatus further comprises resource allocation circuitry, which can control the allocation of the shared resources to the prediction units. The resource allocation circuitry is accordingly configured to determine an allocation of the shared prediction resources to one or more of the plurality of prediction units. This allocation may be determined with the aim of maximising the overall performance increase for the apparatus, for example expressed as the overall operation throughput. Subsequent to determining the allocation, the resource allocation circuitry allocates the shared prediction resources according to the determination.

The present example thus provides improved prediction performance, and thus improves overall processing performance, by way of flexibly allocating shared prediction resources to multiple predictors. This is achieved with lower resource cost than would be incurred without the use of shared prediction resources: in a comparative example in which all prediction resources were solely associated with specific prediction units, a significantly larger overall increase in prediction resources would be required in order to give a comparable overall performance increase. This is because, for example, the resources of a given predictor would be idle when that predictor was not in use (or when that predictor was not operating at full capacity). The present example, in contrast, allows such idle resources to be re-allocated to a different prediction unit. The present example also allows resources to be allocated to the prediction unit with which they would be most effective. For example, as described in more detail below, different prediction units can have differing degrees of impact on overall processing performance depending on properties of a region of instructions which is currently being processed. The present example allows processing resources to be flexibly allocated to the prediction units which are most effective at a given time, thereby maximising the performance increase for a given quantity of resources.

In an example, the resource allocation circuitry performs the above-described determination by assessing a current sensitivity of one or more given prediction units to a change in shared prediction resources allocated to said one or more given prediction units. The resource allocation circuitry then determines an updated allocation based on said asserting. This provides an effective way of allocating the shared resources to the prediction units which will most benefit from the additional resources: the overall impact on processing performance may be higher if the resources are allocated to prediction units which, at a present time, are most sensitive to the provision of additional resources.

For example, the resource allocation circuitry may determine one or more of the given prediction units as being sensitive to a change in allocated shared prediction resources, relative to one or more of the other prediction units. The resource allocation circuitry may then preferentially allocate the shared prediction resources to said relatively sensitive prediction unit(s). This effectively allocates the shared resources to the units which will see the largest benefit.

In some examples, the resource allocation circuitry is configured to perform a feedback loop comprising repeatedly performing the above-described determining of an updated allocation. For example, the allocation of shared resources between the prediction units may be adjusted, and the change in overall performance assessed. By repeatedly performing these steps, the prediction units which are relatively sensitive to the provision of shared resources can be identified. Shared resources can then be allocated to the prediction units which will see the greatest benefit and lead to the greatest increase in overall performance.

As an example of such a feedback loop, the shared prediction resources allocated to one or more of the predictors may be modified. The change in prediction performance, associated with said modifying, can be assessed. A further modification of the shared prediction resource allocation can then be performed, based on the outcome of the assessing.

As described above, the sensitivity of a given prediction unit to a change in shared prediction resources can be assessed by measuring a prediction performance associated with at least the given prediction unit. This may be an assessment of the prediction accuracy of that prediction unit specifically: assessing all prediction units in this manner can provide a fine-grained assessment of per-prediction-unit performance. Alternatively, the prediction performance may be measured by measuring an overall rate at which instructions are processed by the apparatus. This allows the resources to be allocated to the prediction units which will cause the greatest improvement in overall processing performance, without needing to individually track the performance of each individual prediction unit. Thus, overall performance (which is likely more important than the performance of an individual prediction unit, in terms of determining an optimal resource allocation) is efficiently maximised.

Alternatively or additionally, an increase in prediction performance may be determined by way of an increase in data processing throughput, an increase in processing performance, and/or an increased rate at which instructions are performed. These all provide effective ways of quantifying the overall performance improvement associated with a given allocation of shared resources.

In examples, the above-described prediction performance may be quantified by way of one or more prediction performance values which are maintained by, or accessible to, the resource allocation circuitry. For example, such a value may express an overall rate of instruction processing, or a count of a number of processed instructions within a given time period. These provide efficient ways of tracking prediction performance.

In some such examples, the resource allocation circuitry is configured to detect that the processing of operations has entered a new phase, for example a new code region. This may for example be determined based on a hint within the operations (e.g. a series of processing instructions may include a hint that a new code region is to be entered), and/or a change of address space identifier. In response to entering the new code region, the resource allocation circuitry may reset at least one of the prediction performance values to a default value. In this way, prediction performance can be measured specifically within a given region.

The resource allocation circuitry may be configured to store a given determined allocation of shared prediction resources, associated with a given code region. For example, this may be an allocation which was determined as having provided an advantageous increase in overall performance for that code region. The resource allocation circuitry may then be responsive to determining that the processing of operations has re-entered the given code region, allocate the shared prediction resources according to the stored allocation. In this way, previously-determined shared resource allocations can be stored for one or more code regions, ready to be re-used when a given code-region is re-entered. This can improve overall performance relative to a comparative apparatus in which performance is always determined on-the-fly, with no reference to previous results. In some examples, the previously-stored allocation is taken as an initial allocation for the newly re-entered code region, after which an iterative process of refining the allocation is performed as described above.

In some examples, arbitrary allocations of the shared resources to the combination of prediction units can be performed. In other examples, the resource allocation circuitry is configured to maintain a plurality of predefined shared prediction resource allocation. Such resource allocation circuitry can then perform said determining of an allocation by selecting one of the predefined shared prediction resource allocations. This can reduce the processing overhead associated with the allocation of the shared resources, by effectively having a number of preset configurations that can be selected between. This comes at the cost of reduced flexibility in terms of the number of possible permutations of the shared resource allocation.

In an example, the resource allocation is configured to allocate the shared prediction resources to a first prediction unit in chunks of a first size, and to allocate the shared prediction resources to a second prediction unit in chunks of a second size. This allows the allocation to take into account differing requirements of the different prediction units. For example, the first prediction unit may make use of blocks of SRAM of size N, whereas the second prediction unit may make use of blocks of SRAM of size 2N. By allocating shared SRAM to the first prediction unit in chunks of size N, and to the second prediction unit in chunks of size 2N, the shared SRAM can be effectively allocated in such a way that prediction units are not left with unusable resources (as could occur, if, for example, this hypothetical second prediction unit was allocated a SRAM block of size N).

Examples of the present disclosure will now be described with reference to the drawings.

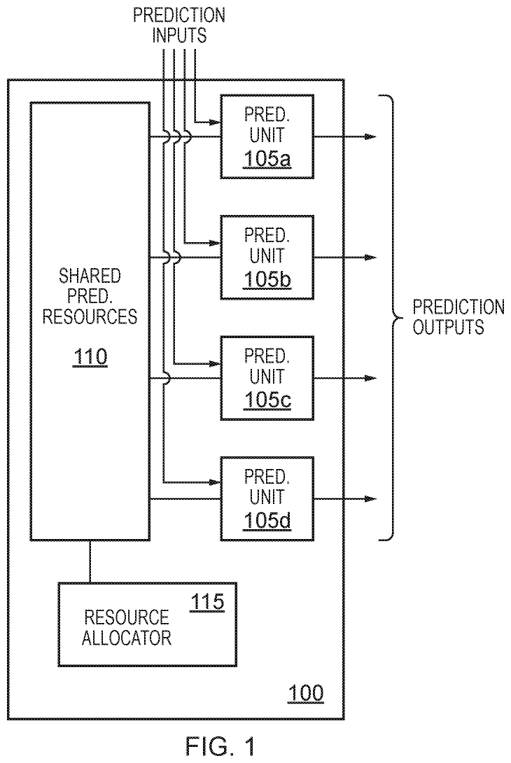

FIG. 1 schematically shows an apparatus 100 according to an example of the present disclosure. The apparatus comprises multiple prediction units 105a, 105b, 105c, 105d. Each of these makes predictions of a different type in respect of processing operations, e.g. instructions, which are being executed. For example, unit 105a may be a branch predictor which predicts the outcomes of branch instructions, and unit 105b may be a data prefetcher which predicts data prior to that data being requested in an instruction.

The prediction units 105a-d receive prediction inputs. These inputs include information regarding the processing of operations, based on which the prediction units 105a-d make their predictions. For example, a data prefetcher 105b may receive the data addresses which are requested by instructions, so that the prefetcher 105b can attempt to detect a pattern of data access and extrapolate that pattern into the future to make predictions of future data access.

Based on the prediction outputs, the prediction units 105a-d makes predictions and outputs corresponding prediction outputs.

Each prediction unit 105a-d may have its own dedicated prediction resources, for use by it alone. The prediction units 105a-d also have access to shared prediction resources 110. Resource allocator 115 controls the allocation of these shared resources to the prediction units 105a-105d, with the aim of improving overall system performance.

The sensitivity of overall system performance to a given resource allocation depends on processing conditions at a given time. As an example, during processing of code including a high density of branch instructions, for example software involving a high degree of user input such as a game, a branch predictor would likely be particularly sensitive to a change in resource allocation. Thus, an increase in resources would be expected to cause a significant increase in overall system performance. Conversely, if a current code region has a low density of branch instructions, this sensitivity would be low: even if an increase in resources would increase the performance of the branch predictor, the low density of branch instructions means that this would not have a high impact on overall system performance.

Thus, in general, whilst prediction unit 105a-d accuracy generally increases as more resources are devoted thereto, the impact on overall system performance of increasing the accuracy of each predictor may not be equal. For example, improving the accuracy of unit 105a by 10% might require 50% more resources and only improve performance by 2% whereas improving the accuracy of prediction unit 105b by 10% might require 20% more resources and improve performance by 8%. In such a case, it would be advantageous to favour an increase in the resources allocated to prediction unit 105b at the expense of unit 105a. The performance improvement numbers observed as a result of predictor circuitry changes are rarely static and vary not only between applications but between phases of an application as well.

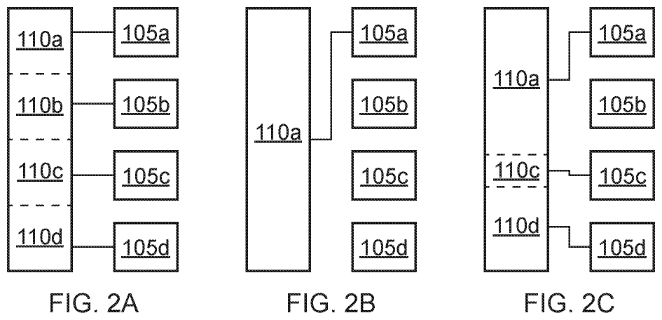

FIGS. 2A to 2C illustrate three potential allocations of the shared prediction resources 110 to the prediction units 105a-d.

FIG. 2A shows a configuration in which the shared resources 110 are shared equally between the prediction units 105a-d: a first quarter 110a of the shared resources 110 is allocated to unit 105a, a second quarter 110b to unit 105b, a third quarter 110c to unit 105c and a fourth quarter 110d to unit 105d. This allocation may be a default allocation, implemented when the resource allocator 115 has no reason to prioritise particular prediction units 105a-105d. For example, this allocation may be used when no particular prediction unit 105a-105d would see a disproportionate advantage from additional resources.

FIG. 2B shows a configuration in which the entirety 110a of the shared resources 110a is allocated to prediction unit 105a, with none of the shared resources being allocated to units 105b-d. This allocation may for example be used at a time when processing conditions are such that an increase in resources allocated to prediction unit 105a would lead to a disproportionately large increase in overall system performance, relative to units 105b-d. Thus, allocating the entirety 110a of the shared resources 110 to unit 105a leads to greater overall system performance than would be observed if the shared resources 110 were allocated more evenly.

FIG. 2C shows a mixed configuration, in which a relatively large portion 110a of the shared resources 110 are allocated to prediction unit 105a, none of the shared resources 110 are allocated to unit 105b, a small portion 110c is allocated to unit 105c, and a medium portion 110d is allocated to portion 105d. This allocation may for example be implemented because the resource allocator 115 has determined that this is the optimal configuration for maximising overall system performance. For example, processing conditions may be such that prediction unit 105a sees a relatively large benefit from increased resources, but with diminishing returns past a certain point such that better performance is seen from sharing some of the shared resources 110 with units 105c and 105d, as opposed to using the configuration of FIG. 2B.

In an example, in order to determine the optimal allocation of shared resources 110 to prediction units 105a-105d, the resource allocator 115 makes use of a runtime learning engine (RLE) which finds the relationship between a change in the resources allocated to each prediction unit 105a-105d and the corresponding change in overall processing performance. By working out this performance gradient for each prediction unit 105a-105d at a given time, the resource allocator 115 can then allocate more resources 110 to prediction units with high performance gradients and fewer resources to prediction units with low performance gradients.

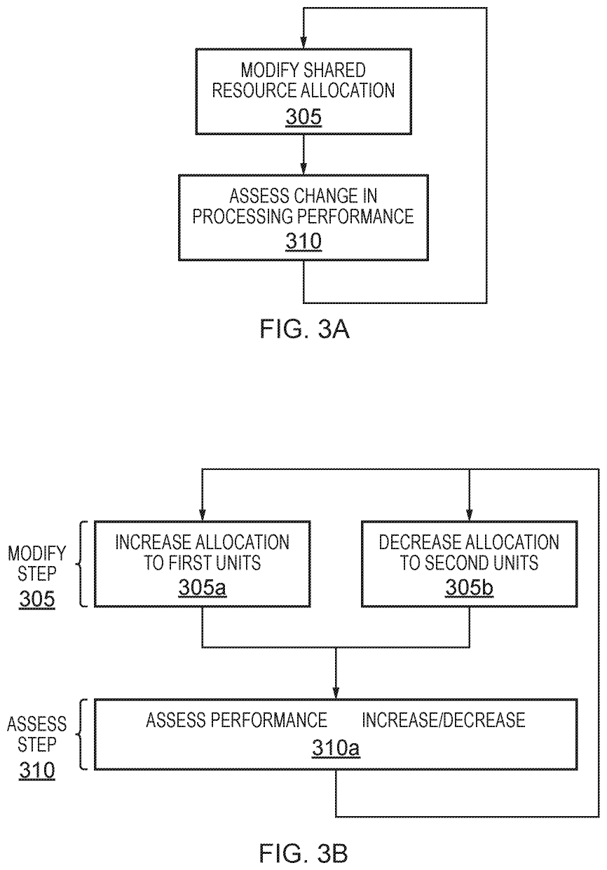

FIGS. 3A and 3B show particular ways in which the resource allocator 115 can assess the performance impact of a change in the allocation of shared resources 110 to prediction units 105a-d.

In FIG. 3A, the method begins by modifying 305 the allocation of shared resources. For example, this may be a perturbation of a previous allocation.

Then, at a later time, the resource allocator 115 assesses 310 the change in performance that arose as a consequence of the allocation modification.

The flow then returns to block 305, and the process is iteratively repeated. Over time, the resource allocator 115 learns which prediction units 105a-d have a particularly large impact on overall processing performance, and can optimise the allocation accordingly.

FIG. 3B shows a more specific example of the method of FIG. 3A. In FIG. 3B, the modification step 305 comprises increasing 305a the quantity of resources allocated to a first set of units, and decreasing 305b the quantity of resources allocated to a second set of units. The assessing step 310 then comprises an assessment 310a of the extent to which performance has increased or decreased since the allocation modification 310.

In some examples, this process can be repeated for each epoch or phase of a program. The epochs or phases are reasonably-sized periods of time during which a program's behaviour can be assumed to be relatively more deterministic. They may for example be different code regions, which may be identified by hint instructions provided by a programmer or compiler. It is generally more difficult to find a deterministic relationship between a change in resource allocation and overall performance over very long periods, and on the other hand, very short periods of time may not enable sufficient data to be gathered for determining the performance gradient. The performance tracking may be reset at the end of a given phase/epoch/region. The length of a phase/epoch/region may be optimised by the resource allocator 115 over time in the same way as the allocation values per se.

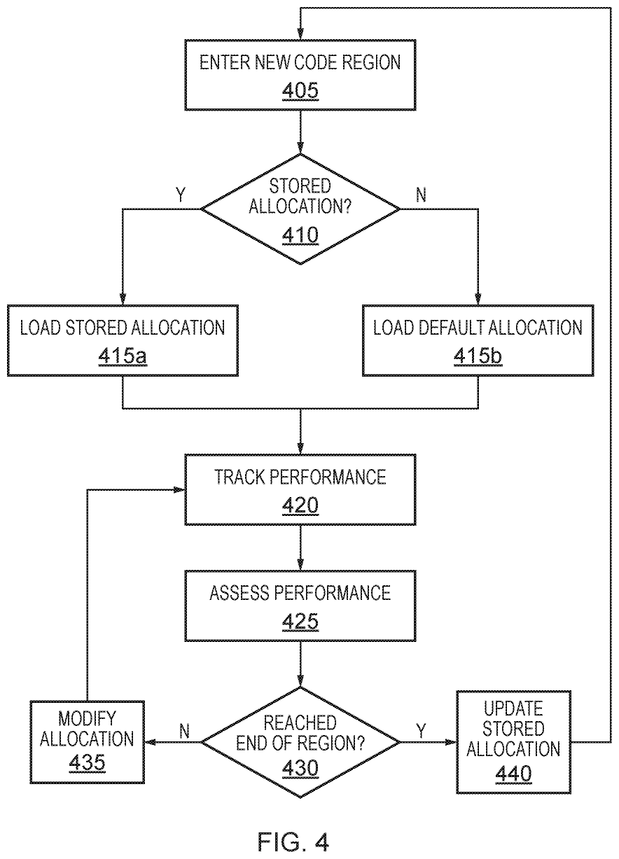

FIG. 4 depicts an example method by which performance may be tracked, and used to inform shared resource allocation, across multiple code regions.

The method begins at block 405, when a new code region is entered.

At block 410, the resource allocator 415 determines whether it has previously stored a shared resource allocation for this code region (e.g. in a previous iteration of the code region). If so, the previously stored allocation is loaded at block 415a. Otherwise, a default allocation is loaded at block 415b. For example, the default allocation may be an equal allocation to each prediction unit 405a-d (as shown for example in FIG. 2A).

At block 420, overall processing performance is tracked for a period of time, and at block 425 the performance change is assessed. At block 430 it is determined whether the end of the region has been reached. If not, the allocation is modified at block 435 based on the assessed performance (e.g. as explained above in relation to FIGS. 3A and 3B). Flow then returns to block 420, and the resource allocator 115 continues to track performance.

If the end of the region has been reached, the stored allocation is updated at block 440. For example, a currently-determined optimal allocation may replace the previous stored allocation, ready to be re-used if the same code region is entered again. Performance can thus be optimised over time.

Flow the returns to block 405, where a new code region is entered.

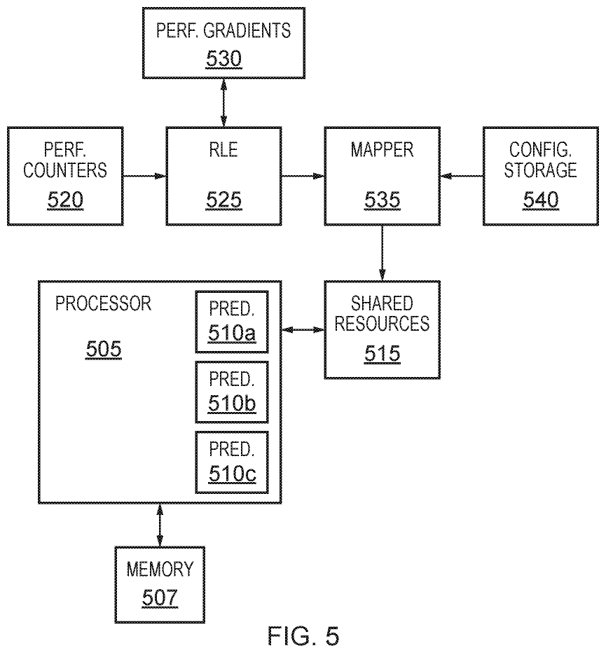

FIG. 5 depicts a system according to an example, which can implement the methods described above.

The system comprises a processor 505 which executes processing instructions retrieved from a memory 507. The instructions define the processing of data, which is also retrieved from the memory 507. The processor comprises prediction units 510a, 510b, 510c which function in the same fashion as the units 105a-d of FIG. 1. The prediction units 510a-c each have their own baseline prediction resources, which are sufficient to provide a baseline level of performance. The prediction units 510a-c also have access to shared prediction resources 515, which function in the same manner as shared resources 110 discussed above.

Performance counters 520 are maintained, which track the processing and/or prediction performance of the processor 505 and the prediction units 510a-c. For example, one of these counters may be a count of a number or rate of executed processing instructions in a current code region.

The performance counters 520 are read by a runtime learning engine (RLE) 525 which, over time, determines performance gradients 530 associated with the predictors 510a-c. The RLE 525 thus learns which prediction units 510a-c should be preferentially allocated shared resources 515, in order to optimise overall processing performance.

The RLE 525 passes this learned information to mapper 535. Based on the learned information, and configuration information from configuration storage 540 (which may for example define the size of functional blocks by which the shared resources 515 can be allocated), the mapper 535 directs the allocation of the shared resources 515 to each prediction unit 510a-c.

The system of FIG. 5 can thus function in the same manner as the apparatus of FIG. 1, with the RLE 525 and mapper 535 corresponding to the resource allocator 115.

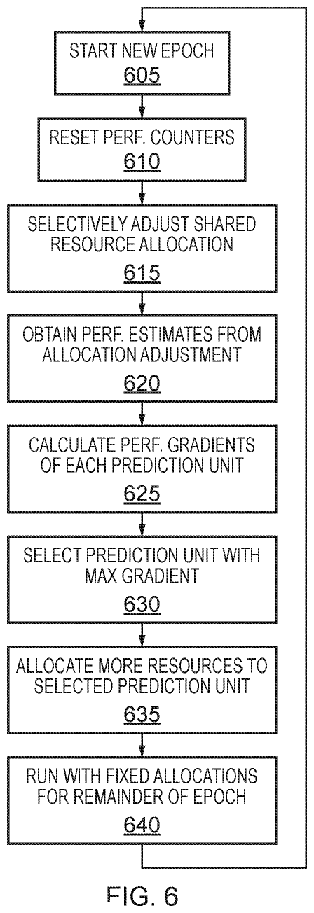

FIG. 6 depicts a method according to an example, which may be implemented by the system of FIG. 5.

At block 605, a new epoch (e.g. a code region or phase) is started. Performance counters 520 are then reset to their default values (e.g. zero) at block 610.

At block 615, the allocation of the shared resources 515 to the prediction units 510a-c is selectively adjusted.

At block 620, an estimation is made of the performance change as a consequence of selective adjustment. For example, this may be based on tracking processing performance for a period of time.

At block 625, performance gradients 530 are calculated for each prediction unit 510a-c.

At block 630, the prediction unit with the highest performance gradient 530 is selected.

At block 635, the mapper 535 allocates more of the shared resources 515 to the selected prediction unit (and reduces the allocation to the other prediction units).

At block 640, the system runs with this allocation for the remainder of the epoch. Flow then returns to block 605, and a new epoch is entered.

The method of FIG. 6 thus provides an effective way of improving system performance by allocating shared resources where they will be most useful.

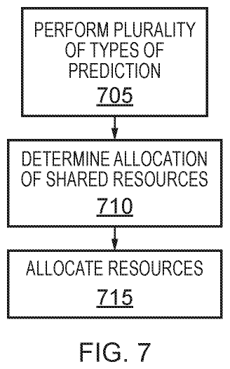

FIG. 7 depicts a method according to an example, which may for example be implemented by the apparatus of FIG. 1.

At block 705, a plurality of types of prediction are performed in respect of instructions that are to be executed. Each type of prediction is performed by a corresponding prediction unit 105a-d.

At block 710, an allocation of shared prediction resources 110, to one or more of said plurality of prediction units 105a-d, is determined. The shared prediction resources 110 are configurable to perform each of said types of prediction.

At block 715, the shared prediction resources 110 are allocated according to the determination.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

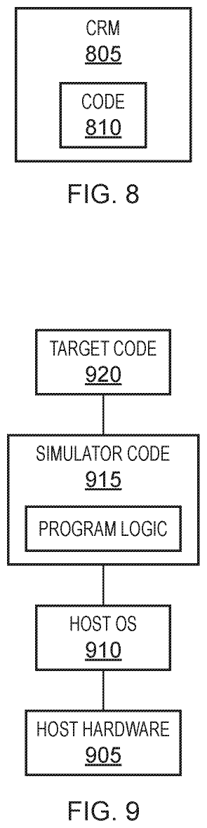

FIG. 8 schematically depicts such a computer-readable medium 805 comprising code 810 for fabrication of an apparatus as described above (e.g. as shown in FIG. 1 or FIG. 5.

FIG. 9 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 905, optionally running a host operating system 910, supporting the simulator program 915. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 905), some simulated embodiments may make use of the host hardware, where suitable.

The simulator program 915 may be stored on a computer-readable storage medium (which may be a non-transitory medium), and provides a program interface (instruction execution environment) to the target code 920 (which may include applications, operating systems and a hypervisor) which is the same as the interface of the hardware architecture being modelled by the simulator program 915. Thus, the program instructions of the target code 920 may be executed from within the instruction execution environment using the simulator program 915, so that a host computer 905 which does not actually have the hardware features of the apparatus 2 discussed above can emulate these features.

Apparatuses and methods are thus provided for improving the performance of processing apparatuses, in particular those which have multiple prediction units.

From the above description it will be seen that the techniques described herein provides a number of significant benefits. In particular, resource allocation can be optimised to maximise overall processing performance.

In the present application, the words “configured to.” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. Apparatus comprising:
prediction circuitry comprising a plurality of prediction units, said plurality comprising a plurality of types of prediction unit, each prediction unit being configured to perform a corresponding type of prediction in respect of operations that are to be executed by the apparatus;
shared prediction resource circuitry comprising shared prediction resources configurable to perform said types of prediction; and
resource allocation circuitry configured to:
determine an allocation of said shared prediction resources to one or more of said plurality of prediction units; and
allocate the shared prediction resources according to the determination.

2. An apparatus according to claim 1, wherein the plurality of types of prediction unit comprises at least two of:
a branch predictor;
a data prefetcher;
an instruction prefetcher;
a load, or store-coalescing predictor;
a congestion predictor;
an execution cluster predictor;
an address collision predictor; and
a snoop predictor.

3. An apparatus according to claim 1, wherein the resource allocation circuitry is configured to perform said determination by:
assessing a current sensitivity of one or more given prediction units to a change in shared prediction resources allocated to said one or more given prediction units; and
determining an updated allocation based on said assessing.

4. An apparatus according to claim 3, wherein the resource allocation circuitry is configured to determine the updated allocation by:
determining one or more of the given prediction units as being sensitive to a change in allocated shared prediction resources, relative to one or more of the other prediction units; and
preferentially allocating additional shared prediction resources to said relatively sensitive prediction units.

5. An apparatus according to claim 4, wherein the resource allocation circuitry is configured to perform a feedback loop comprising repeatedly performing said determining of an updated allocation.

6. An apparatus according to claim 5, wherein said feedback loop comprises iteratively:
modifying the shared prediction resources allocated to one or more of said predictors;
assessing a change in prediction performance associated with said modifying; and
performing a further modification of the shared prediction resource allocation based on said assessing.

7. An apparatus according to claim 3, wherein said assessing the sensitivity of a given prediction unit to a change in shared prediction resources comprises measuring a prediction performance associated with at least said given prediction unit.

8. An apparatus according to claim 7, wherein measuring prediction performance comprises measuring an overall rate at which instructions are processed by the apparatus.

9. An apparatus according to claim 7, wherein the resource allocation circuitry is configured to determine an increase in prediction performance responsive to measuring at least one of:
an increase in data processing throughput;
an increase in processing performance; and
an increased rate at which instructions are processed.

10. An apparatus according to claim 7, wherein measuring prediction performance comprises tracking a prediction accuracy of said given prediction unit.

11. An apparatus according to claim 3, wherein the resource allocation circuitry is configured to measure prediction performance by maintaining at least one prediction performance value.

12. An apparatus according to claim 11, wherein the resource allocation circuitry is configured to:
detect that the processing of said operations has entered a new code region; and
responsive to detecting the new code region, resetting at least one of the prediction performance values to a default value.

13. An apparatus according to claim 12, wherein the resource allocation circuitry is configured to detect the new code region based on at least one of:
a hint within said operations; and
a change of address space identifier.

14. An apparatus according to claim 12, wherein the resource allocation circuitry is configured to:
store a given determined allocation of shared prediction resources, associated with a given code region; and
responsive to determining that the processing of operations has re-entered the given code region, to allocate the shared prediction resources according to the stored allocation.

15. An apparatus according to claim 1, wherein the resource allocation circuitry is configured to:
maintain a plurality of predefined shared prediction resource allocations; and
perform said determining of an allocation by selecting one of the predefined shared prediction resource allocations.

16. An apparatus according to claim 1, wherein the resource allocation circuitry is configured to:
allocate the shared prediction resources to a first prediction unit of the plurality in chunks of a first size; and
allocate the shared prediction resources to a second prediction unit of the plurality in chunks of a second size, the second size being different to the first size.

17. (canceled)

18. An apparatus according to claim 16, wherein:
said one or more storage units comprises one or more memory units; and/or
said one or more processing resource units comprises at least one general purpose lookup table unit, each said general purpose lookup table unit being configurable to be used by each prediction unit of the plurality.

19. A method comprising:
performing a plurality of types of prediction in respect of operations that are to be executed, each type of prediction being performed by a corresponding prediction unit;
determining an allocation of shared prediction resources to one or more of said plurality of prediction units, the shared prediction resources being configurable to perform each of said types of prediction; and
allocating the shared prediction resources according to the determination.

20. (canceled)

21. A computer program for controlling a host data processing apparatus to provide an instruction execution environment comprising:
prediction logic implementing a plurality of prediction units, said plurality comprising a plurality of types of prediction unit, each prediction unit being configured to perform a corresponding type of prediction in respect of operations that are to be executed within the instruction execution environment;
shared prediction resource logic comprising shared prediction resources configurable to perform said types of prediction; and
resource allocation logic configured to:
determine an allocation of said shared prediction resources to one or more of said plurality of prediction units; and
allocate the shared prediction resources according to the determination.
